(19) United States
(12) Patent Application Publication
(10) Pub. No.: US 2026/0331374 A1
(43) Pub. Date: Oct. 22, 2026

(54) MULTILAYER ELECTRONIC COMPONENT

(71) Applicant: SAMSUNG ELECTRO-MECHANICS CO., LTD., Suwon-si (KR)

(72) Inventors: Seon Ho PARK, Suwon-si (KR); Jae Sung PARK, Suwon-si (KR)

(73) Assignee: SAMSUNG ELECTRO-MECHANICS CO., LTD., Suwon-si (KR)

(21) Appl. No.: 19/562,101

(22) Filed: Mar. 10, 2026

(30) Foreign Application Priority Data
Apr. 22, 2025 (KR) 10-2025-0052037

(51) Int. Cl. H01G 4/30; H01G 4/232

(52) U.S. Cl. CPC H01G 4/30; H01G 4/2325

(57) ABSTRACT

A multilayer electronic component includes: a body including a dielectric layer and an internal electrode alternately disposed with the dielectric layer in a first direction, the body including a first surface and a second surface opposing each other in the first direction, a third surface and a fourth surface connected to the first and second surfaces and opposing each other in a second direction, and a fifth surface and a sixth surface connected to the first to the fourth surfaces and opposing each other in a third direction; and an external electrode disposed on the body, wherein the external electrode includes a first electrode layer disposed on the body and connected to the internal electrode, a second electrode layer disposed on the first electrode layer, and a plating layer disposed on the second electrode layer, wherein the second electrode layer includes a thixotropic metal.

### CROSS-REFERENCE TO RELATED APPLICATION(S)

This application claims benefit of priority to Korean Patent Application No. 10-2025-0052037 filed on Apr. 22, 2025, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on printed circuit boards of various types of electronic products, such as an image display device such as a liquid crystal display (LCD), a plasma display panel (PDP), and the like, a computer, a smartphone, a mobile phone, an On Board Charger (OBC) of electric vehicles, a circuit such as a DC-DC converter, and the like, serving to charge or discharge electricity therein or therefrom.

An external electrode of the MLCC includes a primary Cu sintered electrode. A Cu sintered electrode has excellent connectivity with an internal electrode, but the Cu sintered electrode may be vulnerable to external environments such as warpage, heat, and external moisture of the MLCC.

Conventionally, to address the vulnerability of Cu sintered electrode, a conductive resin layer containing a thermosetting resin and a metal filler was formed on the Cu sintered electrode. However, a conductive resin layer has relatively lower moisture resistance than that of an electrode layer formed by sintering a metal paste, and when Ag, or the like was used as a metal filler, problems such as ion migration could occur.

Therefore, there is a need for improvement in an external electrode structure that can alleviate reliability issues that may occur due to a resin included in the conductive resin layer.

### SUMMARY

An aspect of the present disclosure is to improve a problem of increased ESR when a metal filler included in a conventional conductive resin layer is not uniformly distributed.

An aspect of the present disclosure is to alleviate a decrease in bonding force due to a difference in components between a primary electrode layer and a conductive resin layer.

An aspect of the present disclosure is to improve a problem in which a gap between electrode layers is lifted due to outgas generated by a conductive resin layer during solder reflow.

However, the purpose of the present disclosure is not limited to the above-described content, and may be more easily understood in the process of explaining specific embodiments of the present disclosure.

According to an embodiment of the present disclosure, a multilayer electronic component may include a body including a dielectric layer and internal electrodes alternately disposed with the dielectric layer in a first direction, the body including a first surface and a second surface opposing each other in the first direction, a third surface and a fourth surface connected to the first and second surfaces and opposing each other in a second direction, and a fifth surface and a sixth surface connected to the first to fourth surfaces and opposing each other in a third direction; and an external electrode disposed on the body, wherein the external electrode may include a first electrode layer disposed on the body and connected to the internal electrode, a second electrode layer disposed on the first electrode layer, and a plating layer disposed on the second electrode layer, wherein the second electrode layer may include a thixotropic metal.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an embodiment of the present disclosure;

FIG. 2 is a schematic cross-sectional view taken along line I-I’ of FIG. 1;

FIG. 3 schematically illustrates a cross-sectional view taken along line II-II’ of FIG. 1; and

FIG. 4 schematically illustrates an exploded perspective view of a body according to an embodiment.

### DETAILED DESCRIPTION

Hereinafter, specific embodiments of the present disclosure will be described as follows with reference to the attached drawings. The present disclosure may, however, be exemplified in many different forms and should not be construed as being limited to the specific embodiments set forth herein. In addition, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numeral are the same elements in the drawings.

In the drawings, to clearly describe the present disclosure, irrelevant descriptions thereof will be omitted, and the size and thickness of each component illustrated in the drawing are arbitrarily shown for convenience of description, and therefore the present disclosure is not necessarily limited to what is shown. Also, the same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawings, the X-direction (e.g., first direction) may be defined as a thickness direction and may correspond to a stacking direction of the internal electrodes 121 and 122 and the dielectric layer 111. The Y-direction (e.g., second direction) may be defined as a length direction, and the Z-direction may be defined as a width direction.

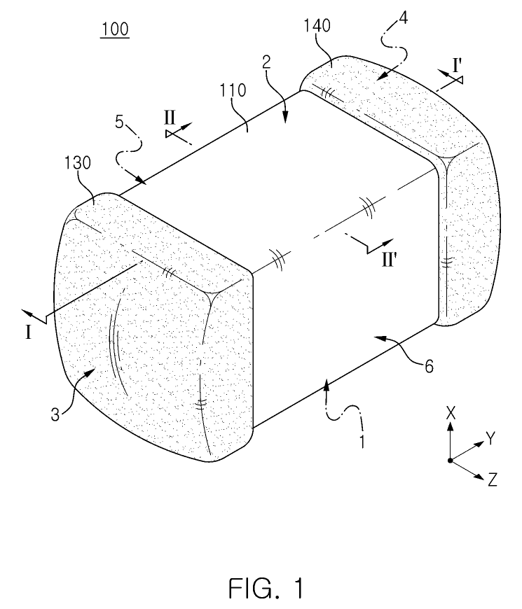

The body 110 is not limited to a particular shape, and may have a hexahedral shape or a shape similar to the hexahedral shape, as illustrated in FIG. 1. The body 110 may not have the shape of a hexahedron having perfectly straight lines because ceramic powder particles included in the body 110 are contracted in a process in which the body is sintered. However, the body 110 may have a substantially hexahedral shape.

Referring to FIG. 1, the body 110 may include first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first to fourth surfaces 1, 2, 3, and 4 and opposing each other in a third direction.

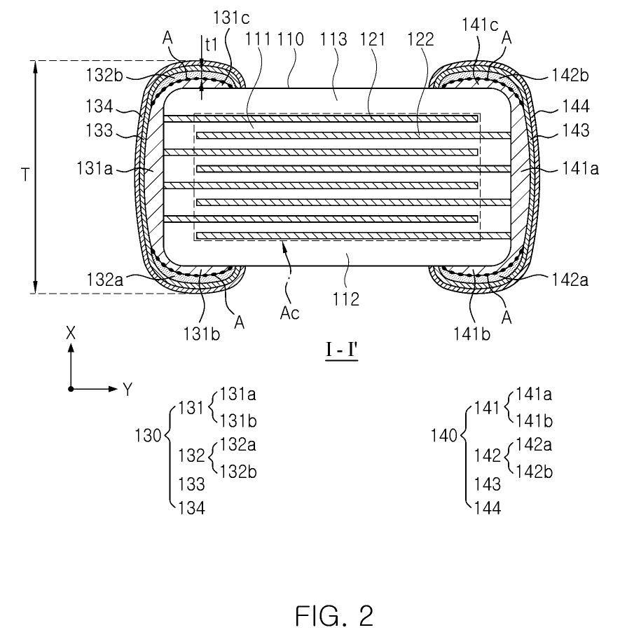

Referring to FIGS. 1 and 2, the third surface 3 and the fourth surface 4 may be surfaces connected to one ends of the internal electrodes 121 and 122, and the fifth surface 5 and the sixth surface 6 may be surfaces spaced apart from the internal electrodes 121 and 122.

A plurality of dielectric layers 111 forming the body 110 may be in a sintered state, and adjacent dielectric layers 111 may be integrated with each other, such that boundaries therebetween may not be readily apparent without the use of a scanning electron microscope (SEM).

A raw material for forming the dielectric layer 111 is not particularly limited, as long as sufficient capacitance may be obtained therewith. For example, a barium titanate-based material, a perovskite (ABO₃)-based material, a lead composite perovskite-based material, a strontium titanate-based material, or the like, may be used. The barium titanate-based material may include BaTiO₃-based ceramic powder, and examples of the ceramic powder may include BaTiO₃, or (Ba₁₋ₓCaₓ)TiO₃(0<x<1), Ba(Ti_{1-y}Ca_{y})O₃(0<y<1), (Ba₁₋ₓCaₓ)(Ti_{1-y}Zr_{y})O₃(0<x<1, 0<y<1), Ba(Ti_{1-y}Zr_{y})O₃(0<y<1), or the like, in which calcium (Ca), zirconium (Zr), or the like is partially dissolved in BaTiO₃, or the like. In addition, the raw material for forming the dielectric layer 111 may include various ceramic additives, organic solvents, binders, dispersants, and the like, added to powder particles such as barium titanate (BaTiO₃) powder particles, or the like, according to an object of the present disclosure.

A thickness “td” of the dielectric layer 111 is not particularly limited.

In order to achieve miniaturization and high capacitance of the multilayer electronic component 100, an average thickness “td” of the dielectric layer 111 may be 0.35 µm or less, and in order to improve the reliability of the multilayer electronic component 100 under high- temperature and high-voltage conditions, the average thickness “td” of the dielectric layer 111 may be 5 µm or more.

The average thickness “td” of the dielectric layer 111 may mean an average thickness of one or more dielectric layers among a plurality of dielectric layers in a first direction.

Meanwhile, the thickness “td” of the dielectric layer 111 may refer to a size of the dielectric layer 111 in the first direction. In addition, the thickness “td” of the dielectric layer 111 may refer to an average thickness “td” of the dielectric layer 111, and may refer to an average size of the dielectric layer 111 in the first direction.

An average size of the dielectric layer 111 in the first direction may be measured by scanning images of cross-sections of the body 110 in the first and second directions with a scanning electron microscope (SEM) at a magnification of 10,000X. More specifically, the average size of a single dielectric layer 111 in the first direction may mean an average value calculated by measuring a size of a single dielectric layer 111 in the first direction at 4 or more equally spaced points in the second direction in the scanned image. The 4 or more equally spaced points may be designated in a capacitance forming portion (Ac). In addition, when the average value is measured by extending the average value measurement to 4 or more dielectric layers 111, the average size of the dielectric layer 111 in the first direction may be further generalized.

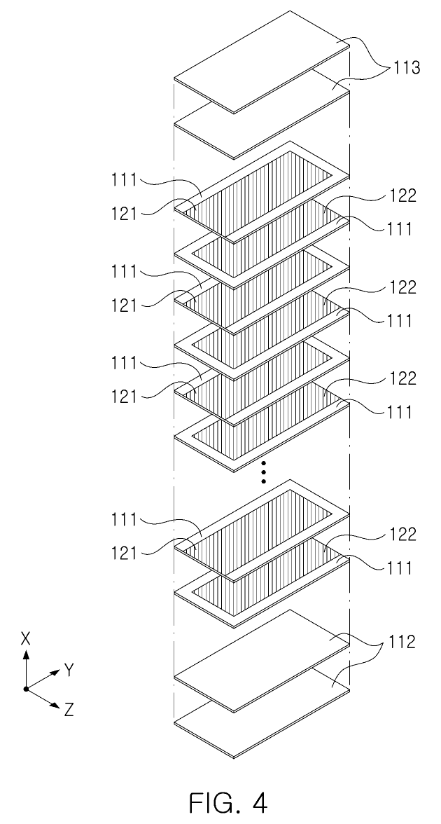

Referring to FIG. 4, the internal electrodes 121 and 122 may be alternately stacked with the dielectric layer 111.

The internal electrodes 121 and 122 may include a first internal electrode 121 and a second internal electrode 122, and the first and second internal electrodes 121 and 122 may be alternately disposed to oppose each other with the dielectric layer 111, constituting the body 110, interposed therebetween, and may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4. A first external electrode 130 may be disposed on the third surface 3 of the body 110 and connected to the first internal electrode 121, and a second external electrode 140 may be disposed on the fourth surface 4 of the body 110 and connected to the second internal electrode 122.

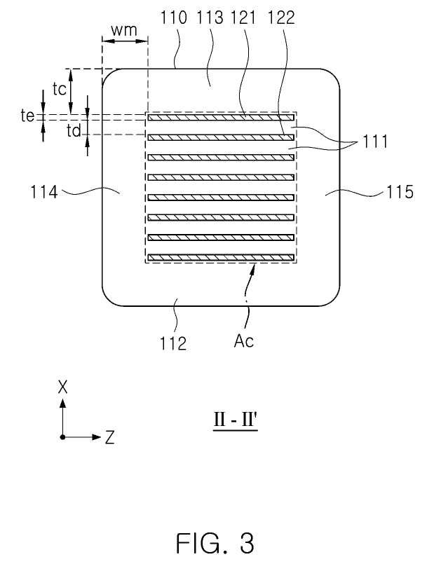

That is, referring to FIG. 3, the first internal electrode 121 may not be connected to the second external electrode 140 but may be connected to the first external electrode 130, and the second internal electrode 122 may not be connected to the first external electrode 130 but may be connected to the second external electrode 140. In this case, the first and second internal electrodes 121 and 122 may be electrically separated from each other by the dielectric layer 111 interposed therebetween.

Meanwhile, the body 110 may be formed by alternately stacking a ceramic green sheet on which the first internal electrode 121 is printed, and a second ceramic green sheet on which the second internal electrode 122 is printed, and then sintering the stacked ceramic green sheets.

A material for forming the internal electrodes 121 and 122 is not particularly limited, and a material having excellent electrical conductivity may be used. For example, the internal electrodes 121 and 122 may include at least one of nickel (Ni), copper (Cu), palladium (Pd), silver (Ag), gold (Au), platinum (Pt), tin (Sn), tungsten (W), titanium (Ti), and alloys thereof.

In addition, the internal electrodes 121 and 122 may be formed by printing a conductive paste for internal electrodes containing one or more of nickel (Ni), copper (Cu), palladium (Pd), silver (Ag), gold (Au), platinum (Pt), tin (Sn), tungsten (W), titanium (Ti), and alloys thereof on the ceramic green sheet. The printing method of the conductive paste for internal electrodes may use a screen-printing method or a gravure printing method, but the present disclosure is not limited thereto.

Meanwhile, a thickness “te” of the internal electrodes 121 and 122 is not particularly limited.

In order to achieve miniaturization and high capacitance of the multilayer electronic component 100, an average thickness “te” of the internal electrodes 121 and 122 may be 0.35 μm or less, and in order to achieve improving the reliability of the multilayer electronic component 100 under high-temperature and high-voltage conditions, the average thickness “te” of the internal electrodes 121 and 122 may be 1 μm or more.

The average thickness “te” of the internal electrodes 121 and 122 may mean an average thickness of one or more internal electrodes 121 and 122 in the first direction among the plurality of internal electrodes 121 and 122.

The average thickness “te” of the internal electrodes 121 and 122 may be measured by scanning images of cross-sections of the body 110 in the first and second directions with a scanning electron microscope (SEM) at a magnification of 10,000X. More specifically, the average thickness “te” of a single internal electrode 121, 122 may be an average value calculated by measuring a size of a single internal electrode in the first direction at 4 or more equally spaced points in the second direction in the scanned image. The 4 or more equally spaced points may be designated in a capacitance forming portion (Ac). In addition, when the average value is measured by extending the average value measurement to 4 or more internal electrodes 121 and 122, the average size of the plurality of internal electrodes 121 and 122 in the first direction may be further generalized.

Meanwhile, referring to FIG. 3, the body 110 may include cover portions 112 and 113 disposed on both end surfaces of the capacitance forming portion (Ac) in the first direction.

The cover portions 112 and 113 may be formed by disposing or stacking a single dielectric layer 111 or two or more dielectric layers 111 on upper and lower surfaces of the capacitance forming portion (Ac) in the first direction, respectively, and may basically play a role in preventing damage to the internal electrodes 121 and 122 due to physical or chemical stress.

The cover portions 112 and 113 may not include the internal electrodes 121 and 122, and may include the same dielectric material as the dielectric layer 111. That is, the cover portions 112 and 113 may include a ceramic material, for example, a barium titanate (BaTiO₃)-based ceramic material.

Meanwhile, a thickness “tc” of the cover portions 112 and 113 is not particularly limited.

However, to more easily achieve miniaturization and high capacitance of the multilayer electronic component 100, the thickness “tc” of the cover portions 112 and 113 may be 100 μm or less, and preferably 30 μm or less, and in the case of ultra-small products, the thickness “tc” thereof may be more preferably 20 μm or less.

Here, the thickness “tc” of the cover portions 112 and 113 may mean a size of the cover portions 112 and 113 in the first direction. In addition, the thickness “tc” of the cover portions 112 and 113 may mean an average thickness “tc” of the cover portions 112 and 113, and may mean an average size of the cover portions 112 and 113 in the first direction.

An average size of the cover portions 112 and 112 in the first direction may be measured by scanning images of cross-sections of the body 110 in the first and second directions with a scanning electron microscope (SEM) at a magnification of 10,000X. More specifically, the average size may be an average value calculated by measuring a size of a single cover portion in the first direction at 30 equally spaced points in the second direction in the scanned image of a single cover portion.

In addition, the average size of the cover portion in the first direction, measured by the method described above may have a size substantially the same as the average size of the cover portion in the first direction, in the cross-sections of the body 110 in the first and third directions.

Meanwhile, referring to FIG. 5, margin portions 114 and 115 may be disposed on both surfaces of the capacitance forming portion (Ac), opposing each other in the third direction.

As illustrated, the margin portions 114 and 115 may refer to a region between both ends of the first and second internal electrodes 121 and 122 in the third direction and a boundary surface of the body 110, based on the cross-sections of the body 110 in the first and third directions.

The margin portions 114 and 115 may basically play a role in preventing damage to the internal electrodes 121 and 122 due to physical or chemical stress.

The margin portions 114 and 115 may be formed by applying a conductive paste to a ceramic green sheet, except for a region in which the margin portions 114 and 115 are to be formed, to form internal electrodes 121 and 122, and to suppress a step difference due to the internal electrodes 121 and 122, cutting the body 110 so that the internal electrodes 121 and 122 after lamination are exposed to the fifth and sixth surfaces 5 and 6 of the body 110, and then disposing and stacking a single dielectric layer 111 or two or more dielectric layers 111 in the third direction on both end-surfaces of the capacitance forming portion (Ac) in the third direction.

The margin portions 114 and 115 may not include the internal electrodes 121 and 122, and may include the same material as the dielectric layer 111. That is, the margin portions 114 and 115 may include a ceramic material, and may include for example, a barium titanate (BaTiO₃)-based ceramic material.

Meanwhile, a width of the margin portions 114 and 115 is not particularly limited.

However, to more easily achieve miniaturization and high capacitance of the multilayer electronic component 100, the width of the margin portions 114 and 115 may be 100 μm or less, and preferably 30 μm or less, and in the case of ultra-small products, the width thereof may be more preferably 20 μm or less.

Here, the width of the margin portions 114 and 115 may mean a size of each of the margin portions 114 and 115 in the third direction. In addition, the width of the margin portions 114 and 115 may mean an average width “wm” of the margin portions 114 and 115, and may mean an average size of the margin portions 114 and 115 in the third direction.

The average size of the margin portions 114 and 115 may be measured by scanning images of cross-sections of the body 110 in the first and third directions with a scanning electron microscope (SEM) at a magnification of 10,000X. More specifically, the average size may be an average size calculated by measuring a size of a single margin portion in the third direction at 10 equally spaced points in the first direction in the scanned image of a single margin portion.

Referring to FIG. 1, external electrodes 130 and 140 are disposed on the body 110.

The external electrodes 130 and 140 may include first electrode layers 131 and 141 disposed on the body 110 and connected to the internal electrodes 121 and 122.

The first electrode layers 131 and 141 may be in contact with at least a portion of the internal electrodes 121 and 122 to secure electrical connectivity between the external electrodes 130 and 140 and the internal electrodes 121 and 122.

The first electrode layers 131 and 141 may include connection portions 131a and 141a disposed on the third and fourth surfaces 3 and 4, and band portions 131b, 131c, 141b, and 141c extending from the connection portions 131a and 141a onto the first and second surfaces 1 and 2.

The band portions 131b, 131c, 141b, and 141c may include lower band portions 131b and 141b disposed on the first surface 1 and upper band portions 131c and 141c disposed on the second surface 2.

Meanwhile, although not illustrated, the first electrode layers 131 and 141 may include a side band portion disposed to extend from the connection portions 131a and 141a onto the fifth and sixth surfaces 5 and 6.

The first electrode layers 131 and 141 may include one or more conductive metals such as nickel (Ni), copper (Cu), and alloys thereof. However, in order to improve electrical connectivity and sinterability with the internal electrodes 121 and 122, the first electrode layers 131 and 141 according to an embodiment may include Cu as a conductive metal, and may include glass.

The first electrode layers 131 and 141 may be formed by dipping and sintering a conductive paste containing a conductive metal and glass onto the third surface 3 and the fourth surface 4 of the body 110, or by attaching and sintering a sheet containing a conductive metal and glass to the third surface 3 and the fourth surface 4 of the body 110, but the present disclosure is not limited thereto.

In the conventional case of improving bending strength of a multilayer electronic component by forming a conductive resin layer containing a thermosetting resin and a metal filler on the first electrode layers 131 and 141, problems such as a decrease in moisture resistance reliability or the occurrence of ion migration may occur. In addition, during a solder reflow process for mounting the multilayer electronic component on a substrate, outgas may be generated by the conductive resin layer, which may cause interlayer lifting of an external electrode.

On the other hand, in the multilayer electronic component 100 according to an embodiment of the present disclosure, since the second electrode layers 132 and 142 including a thixotropic metal are disposed on the first electrode layers 131 and 141, the above-described problems that may occur as the conductive resin layer is disposed on the first electrode layers 131 and 141 may be solved.

A thixotropic material is a material of which a modulus thereof changes depending on shear force applied to the material. The thixotropic material may be formed of a metal alloy, or the like, and when the second electrode layers 132 and 142 are formed of such a thixotropic material, the second electrode layers 132 and 142 may include a thixotropic metal.

The second electrode layers 132 and 142 according to an embodiment of the present disclosure includes a thixotropic metal instead of a conventional thermosetting resin, so that the electrical conductivity may be superior to that of a conventional conductive resin layer, and may have excellent ductility even though the second electrode layers 132 and 142 do not include a thermosetting resin. Accordingly, the ESR of the multilayer electronic component 100 may be reduced and the bending strength may be improved.

Meanwhile, the second electrode layers 132 and 142 may be formed by forming the first electrode layers 131 and 141 on the body 110 and then pressing a thixotropic metal pad formed by thixostamping on sides of the first surface 1 and the second surface 2 of the body 110 at a temperature of 550°C or higher, but the present disclosure is not limited thereto.

In an embodiment, the thixotropic metal may be an alloy including Al, Si, and Mg, and more specifically, an alloy including more than 0 mol parts and less than or equal to 8 mol parts of Si per 100 mol parts of Al, and more than 0 mol parts and less than or equal to 0.7 mol parts of Mg per 100 mol parts of Al.

The second electrode layers 132 and 142 may include a thixotropic metal, and may include a metal element as a main component. Specifically, in an embodiment, a content of a metal element included in the second electrode layers 132 and 142 may be 90 at% or more, relative to the total elements included in the second electrode layers 132 and 142. Accordingly, an effect of reducing the ESR of the multilayer electronic component 100 may be more significant. The content of the metal element may be determined by energy dispersive X-ray spectroscopy (EDX). Other methods and/or tools appreciated by one of ordinary skill in the art, even if not described in the present disclosure, may also be used.

Meanwhile, the second electrode layers 132 and 142 may include a thixotropic metal, and may be composed only of metal elements. Specifically, the second electrode layers 132 and 142 may not include glass, so that the effect of reducing the ESR of the multilayer electronic component 100 may be more significant.

When the second electrode layers 132 and 142 includes a thixotropic metal, which is an alloy containing Al, Si, and Mg, a secondary phase containing Mg₂Si may be formed during a solidification process of the second electrode layer. The Mg₂Si secondary phase may play a role in further improving the mechanical strength of the second electrode layers 132 and 142. That is, in an embodiment, the second electrode layer 132 and 142 may include Mg₂Si, and accordingly, an effect of improving the bending strength of the multilayer electronic component 100 may become more significant.

Referring to FIG. 2, an alloy (A) may be disposed between the first electrode layers 131 and 141 and the second electrode layers 132 and 142. The alloy (A) may be formed between the first electrode layers 131 and 141 and the second electrode layers 132 and 142 when the first electrode layers 131 and 141 include Cu and the second electrode layers include Al, and the alloy (A) may be a Cu-Al alloy formed by a reaction between Cu included in the first electrode layers 131 and 141 and Al of the second electrode layers 132 and 142. In an embodiment, by disposing an alloy (A) including Cu and Al between the first electrode layers 131 and 141 and the second electrode layers 132 and 142, the electrical connectivity between the first electrode layers 131 and 141 and the second electrode layers 132 and 142 can be improved, and accordingly, the ESR of the multilayer electronic component 100 may be further reduced.

Meanwhile, when thicknesses of the second electrode layers 132 and 142 are excessive, excessive stress may be applied to a region of the external electrodes 130 and 140 disposed on the first surface 1 or the second surface 2 of the body 110 due to tensile deformation of the multilayer electronic component 100, and accordingly, the bending strength of the multilayer electronic component 100 may be reduced. Accordingly, in an embodiment, when a maximum thickness of the external electrodes 130 and 140 in the first direction is T, and a maximum thickness of the second electrode layers 132 and 142 in the first direction is t1, by adjusting t1/T to 0.05 or less, the phenomenon of reduced bending strength of the multilayer electronic component 100 may be alleviated. The values of T and t1 may be determined by scanning electron microscope (SEM), transmission electron microscope (TEM), scanning transmission electron microscope (STEM). Other methods and/or tools appreciated by one of ordinary skill in the art, even if not described in the present disclosure, may also be used.

Meanwhile, a lower limit value of t1/T is not particularly limited, and may be adjusted differently depending on a size of the multilayer electronic component 100.

Referring to FIG. 2, the second electrode layers 132 and 142 according to an embodiment may be disposed on band portions 131b, 131c, 141b, and 141c of the first electrode layers 131 and 141. Therefore, a proportion of the external electrodes 130 and 140 in the multilayer electronic component 100 may be minimized, and the ESR characteristics and bending strength of the multilayer electronic component 100 may be improved.

Meanwhile, in an embodiment, the first electrode layers 131 and 141 may include a corner portion connecting the connection portions 131a and 141a and the band portions 131b, 131c, 141b, and 141c. The corner portion of the first electrode layers 131 and 141 is a region formed on a corner of the body 110, and may be a region having a thinner thickness than other regions, resulting in weaker mechanical strength and vulnerability to external moisture penetration. Accordingly, in an embodiment, the second electrode layers 132 and 142 may be disposed to extend from the band portions 131b, 131c, 141b, and 141c onto the corner portion, thereby further improving the mechanical strength and moisture resistance reliability of the multilayer electronic component 100.

In an embodiment, the second electrode layers 132 and 142 may be disposed not to cover the connection portions 131a and 141a of the first electrode layers 131 and 141. Specifically, the second electrode layers 132 and 142 may be disposed to be spaced apart from the capacitance forming portion (Ac) in the second direction, thereby preventing a proportion of the external electrodes 130 and 140 in the multilayer electronic component 100 from increasing excessively.

As illustrated in FIGS. 1 and 2, the second electrode layers 132 and 142 may include electrode layers 132a and 142a disposed on the first surface 1 of the body 110 and electrode layers 132b and 142b disposed on the second surface 2 of the body 110.

Although not illustrated in FIGS. 1 and 2, when the first electrode layers 131 and 141 include a side band portion, the second electrode layers 132 and 142 may further include an electrode layer disposed on the side band portion of the first electrode layer 131 and 141.

Plating layers 133, 134, 143, and 144 may be disposed on the second electrode layers 132 and 142.

The plating layers 133, 134, 143, and 144 may include Ni plating layers 133 and 143 covering the first electrode layers 131 and 141 and the second electrode layer 132 and 142 and Sn plating layers 134 and 144 disposed on the Ni plating layers 133 and 143.

The plating layers 133, 134, 143, and 144 may serve to improve the sealing properties and mounting characteristics of the multilayer electronic component 100. The type of the plating layers 133, 134, 143, and 144 is not particularly limited, and may be plating layers containing one or more of Ni, Sn, Pd, and alloys thereof, and may be formed of a plurality of layers.

In an embodiment, the plating layers 133, 134, 143, and 144 may include Ni plating layers 133 and 134 covering the first electrode layers 131 and 141 and the second electrode layers 132 and 142, and accordingly, the sealing properties of the multilayer electronic component 100 may be improved.

In an embodiment, the plating layers 133, 134, 143, and 144 may include Sn plating layers 134 and 144 disposed on the Ni plating layers 133 and 143, and accordingly, the mountability of the multilayer electronic component 100 may be improved.

Meanwhile, in an embodiment, only a structure in which the Ni plating layers 133 and 143 and the Sn plating layers 134 and 144 are sequentially disposed has been described, but the present disclosure is not limited thereto, and the plating layers 133, 134, 143, and 144 may be plating layers including one or more of Ni, Sn, Pd, and alloys thereof, and may be formed of a plurality of layers.

As set forth above, as one of the many effects of the present disclosure, by disposing a second electrode layer including a thixotropic metal on a first electrode layer, equivalent series resistance (ESR) of a multilayer electronic component may be reduced.

As one of the many effects of the present disclosure, by disposing a second electrode layer including a thixotropic metal on a first electrode layer, bending strength of a multilayer electronic component may be improved.

As one of the many effects of the present disclosure, by disposing a second electrode layer including a thixotropic metal on a first electrode layer, in the case in which a conductive resin layer is formed on a first electrode layer, a problem in which a gap between the electrode layers is lifted during solder reflow may be solved.

However, various advantages and effects of the present disclosure are not limited to the above-described contents, and may be more easily understood in a process of explaining specific embodiments of the present disclosure.

Although the embodiments of the present disclosure have been described in detail above, the present disclosure is not limited by the above-described embodiments and the attached drawings, but is intended to be limited by the appended claims. Accordingly, various forms of substitution, modification, and change may be made by those skilled in the art within the scope that does not depart from the technical idea of the present disclosure described in the claims, and this will also fall within the scope of the present disclosure.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it can be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

While example embodiments have been illustrated and described above, it will be apparent to those skilled in the art that modifications and variations could be made without departing from the scope of the present disclosure as defined by the appended claims.

What is claimed is:

1. A multilayer electronic component, comprising:
a body including a dielectric layer and internal electrodes alternately disposed with the dielectric layer in a first direction, the body including a first surface and a second surface opposing each other in the first direction, a third surface and a fourth surface connected to the first and second surfaces and opposing each other in a second direction, and a fifth surface and a sixth surface connected to the first to fourth surfaces and opposing each other in a third direction; and
an external electrode disposed on the body,
wherein the external electrode includes:
a first electrode layer disposed on the body and connected to the internal electrode,
a second electrode layer disposed on the first electrode layer, and
a plating layer disposed on the second electrode layer,
wherein the second electrode layer includes a thixotropic metal.

2. The multilayer electronic component of claim 1, wherein the thixotropic metal is an alloy that includes Al, Si and Mg.

3. The multilayer electronic component of claim 1, wherein a content of a metal element included in the second electrode layer is 90 at% or more, relative to a total content of elements included in the second electrode layer.

4. The multilayer electronic component of claim 2, wherein the second electrode layer further includes Mg₂Si.

5. The multilayer electronic component of claim 1, wherein the second electrode layer is free of glass.

6. The multilayer electronic component of claim 2, wherein the first electrode layer includes Cu, and
the external electrode includes an alloy including both Cu and Al, where the alloy is disposed between the first electrode layer and the second electrode layer.

7. The multilayer electronic component of claim 1, wherein, when a maximum thickness of the external electrode in the first direction is T, and a maximum thickness of the second electrode layer in the first direction is t1,
t1/T is 0.05 or less.

8. The multilayer electronic component of claim 1, wherein the first electrode layer includes a connection portion disposed on the third and fourth surfaces, and a band portion disposed to extend from the connection portion onto the first and second surfaces, and
the second electrode layer is disposed on the band portion.

9. The multilayer electronic component of claim 8, wherein the first electrode layer further includes a corner portion connecting the connection portion and the band portion, and
the second electrode layer is disposed to extend from the band portion onto the corner portion.

10. The multilayer electronic component of claim 1, wherein the body includes a capacitance forming portion that includes the internal electrodes overlapping the dielectric layer in the first direction, and
the second electrode layer is disposed to be spaced apart from the capacitance forming portion in the second direction.

11. The multilayer electronic component of claim 1, wherein the first electrode layer includes Cu and glass.

12. The multilayer electronic component of claim 1, wherein the plating layer includes a Ni plating layer covering the first electrode layer and the second electrode layer, and a Sn plating layer disposed on the Ni plating layer.

13. The multilayer electronic component of claim 1, wherein the thixotropic metal is an alloy that includes at least one selected from the group consisting of Si, Al, and Mg.

14. The multilayer electronic component of claim 8, wherein the second electrode layer is not disposed on the connection portion.

15. A method of manufacturing the multilayer electronic component of claim 1, comprising:
forming the first electrode layer on the body, and
pressing a pad including the thixotropic metal on the first electrode layer disposed on the first surface and the second surface of the body to form the second electrode layer.

16. The method of claim 15, wherein the pressing is performed at a temperature of 550°C or higher.

17. The method of claim 15, wherein the pad is formed by thixostamping.
